(19) United States
(12) Patent Application Publication
(10) Pub. No.: US 2014/0317171 A1
(43) Pub. Date: Oct. 23, 2014

(54) METHODS AND APPARATUS FOR USER INTERFACE NAVIGATION

(71) Applicant: Samples and Results, LLC, Cheyenne, WY (US)

(72) Inventors: Jason Fox, Scottsdale, AZ (US); Ryan Yarter, Gilbert, AZ (US); Jonathan Hardwick, Tempe, AZ (US)

(21) Appl. No.: 14/216,860

(22) Filed: Mar. 17, 2014

Related U.S. Application Data
(60) Provisional application No. 61/794,833, filed on Mar. 15, 2013.

(51) Int. Cl. H04L 29/06

(52) U.S. Cl. CPC H04L 67/42
USPC 709/203

(57) ABSTRACT

Methods and apparatus for user interface navigation may facilitate altering the output of a user interface in response to a predetermined action. Methods and apparatus for user interface navigation may cause a user interface presenting a first resource to present a static and/or dynamically created landing resource upon a user performing a predetermined action. The landing resource may comprise a website, an application, and the like. Methods and apparatus for user interface navigation may cause the user interface to present a return resource to the user upon the user performing the same or different predetermined action. In some embodiments, the return resource may comprise the first resource.

### CROSS-REFERENCES TO RELATED APPLICATIONS

This application claims the benefit of U.S. Provisional Patent Application No. 61/794,833, filed Mar. 15, 2013, entitled METHODS AND APPARATUS FOR A WEBSITE, and incorporates its disclosure by reference.

### BACKGROUND OF THE INVENTION

Current methods for navigating a user interface require a user to particularly select an item to be presented by the user interface. For example, a user operating a web browser must directly enter a URL, use a link, use a bookmark, and the like, to navigate between web locations. Further, navigation between multiple websites or applications can be cumbersome, for example requiring a user to look through a browsing history or repeatedly click a “back” button on the web browser to return to a previously-viewed website. In addition, the selected item presented by the user interface may not be customized to the user.

### SUMMARY OF THE INVENTION

Methods and apparatus for user interface navigation may facilitate altering the output of a user interface in response to a predetermined action. Methods and apparatus for user interface navigation may cause a user interface presenting a first resource to present a static and/or dynamically created landing resource upon a user performing a predetermined action. The landing resource may be customized to the user. The landing resource may comprise a website, an application, and the like. Methods and apparatus for user interface navigation may cause the user interface to present a return resource to the user upon the user performing the same or different predetermined action. In some embodiments, the return resource may comprise the first resource.

### BRIEF DESCRIPTION OF THE DRAWING FIGURES

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a user interface navigation method;

FIG. 2A is a block diagram representatively illustrating a user interface navigation system;

FIG. 2B is a block diagram of a computing device capable of operating an embodiment of the present invention; and

FIG. 3 representatively illustrates a user interface navigation method.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ systems, technologies, devices, algorithms, designs, services, and the like, which may carry out a variety of functions. In addition, the present technology may be practiced in conjunction with any number of hardware and software applications and environments. For example, the present technology may be practiced in conjunction with any number of websites, software applications, advertising networks, news networks and news feed, and computing devices such as servers, computer databases, personal computers, and portable computing devices, and the system described is merely one exemplary application for the invention.

Methods and apparatus for user interface navigation according to various aspects of the present technology may operate in conjunction with any suitable computing process or device, interactive system, input system or method, output system or method, and/or telecommunication network. Various representative implementations of the present technology may be applied to any computing device or application configured to communicate via a telecommunication network. Certain representative implementations may comprise, for example, program code stored on any combination of computing devices, wherein the program code facilitates analyzing user input and/or other user information and redirecting a user interface. Various representative algorithms may be implemented with any combination of data structures, objects, processes, routines, other programming elements, and computing components and/or devices.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or presenting content, interfacing a computing device to a network, transmitting and/or receiving data, providing a user interface, communicating information, interfacing with a user, detecting and/or analyzing input to a computing device, gathering data, tracking advertisement interactions, collecting and managing user accounts and information, calculating statistics, and the like.

A computing device may comprise conventional components, such as a processor, a local memory such as RAM, long term memory such as a hard disk, a network adaptor, and any number of input and/or output devices such as a keyboard, mouse, monitor, touch screen, microphone, speaker, motion sensor, orientation sensor, light sensor, and the like. The various memories of the computing device may facilitate the storage of one or more computer instructions, such as a software routine and/or software program, which may be executable by the processor to perform the methods of the invention. A computing device may comprise a personal computer, server, mobile phone, smart phone, tablet computer, kiosk, portable computer, and the like. Further, the databases, systems, and/or components of the present technology may consist of any combination of databases, systems, and/or components at a single location or at multiple locations. Each database, system, and/or component of the present technology may comprise any suitable security features, such as firewalls, access codes, encryption, de-encryption, compression, decompression, and/or the like.

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a computer program product on a computer-readable storage medium having computer-readable program code embodied in the storage medium. Any suitable computer-readable storage medium may be utilized, including any combination of hard disks, CD-ROM, optical storage devices, magnetic storage devices, USB memory devices, any appropriate volatile or non-volatile memory system, and the like. The present technology may take the form of a downloadable and/or cloud-based non-downloadable computer program product and/or methods.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

Methods and apparatus for user interface navigation according to various aspects of the present technology may facilitate altering or changing the output of a user interface in response to a predetermined action. Methods and apparatus for user interface navigation according to various aspects of the present technology may cause a user interface (UI) presenting a first resource to present a static and/or dynamically created landing resource to a user upon the user performing a predetermined action, and may cause the UI to present a return resource to the user upon the user performing the same or different predetermined action.

A resource may comprise anything that can be identified, named, addressed, accessed, or handled, in any way, by a computing device, in the World Wide Web, in the Internet, or in any other network. For example, a resource may comprise a website, HTML document, FTP site, a file, an email composition window (e.g. using the “mailto” Uniform Resource Identifier (URI) scheme), a Google Play application or window (e.g. using the “market” URI scheme), any referent of a URI or protocol, a web browser window, a software application, a segment of software code, a software subroutine, and the like. The UI may comprise any suitable application for retrieving (e.g. requesting and/or receiving, possibly including short- and/or long-term storage), opening, executing, presenting, navigating, or otherwise traversing resources. For example, a UI may comprise a web browser such as Microsoft Internet Explorer, Mozilla Firefox, Google Chrome, Apple Safari, and the like. The UI may comprise the user interface of an operating system (e.g. the desktop environment of an operating system). Directing (including navigating, as used herein) the UI to a resource may comprise causing the UI to retrieve, open, present, and/or otherwise execute the resource.

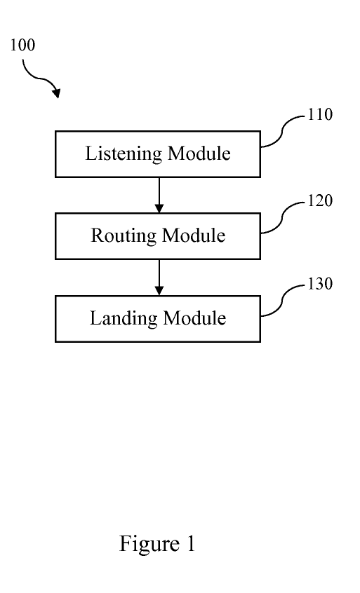

Referring to FIG. 1, methods and apparatus for user interface navigation 100 may comprise a listening module 110, a routing module 120, and a landing module 130. The listening module 110 may comprise any suitable system or method for observing user input and directing the UI to a resource. The routing module 120 may comprise any suitable system or method for managing segment data (described below), identifying a resource, and directing the UI to a resource. The landing module 130 may comprise any suitable system or method for determining content to present and causing the UI to present the determined content. In some embodiments, the landing module 130 may also comprise any suitable system or method for observing user input and directing the UI to a resource.

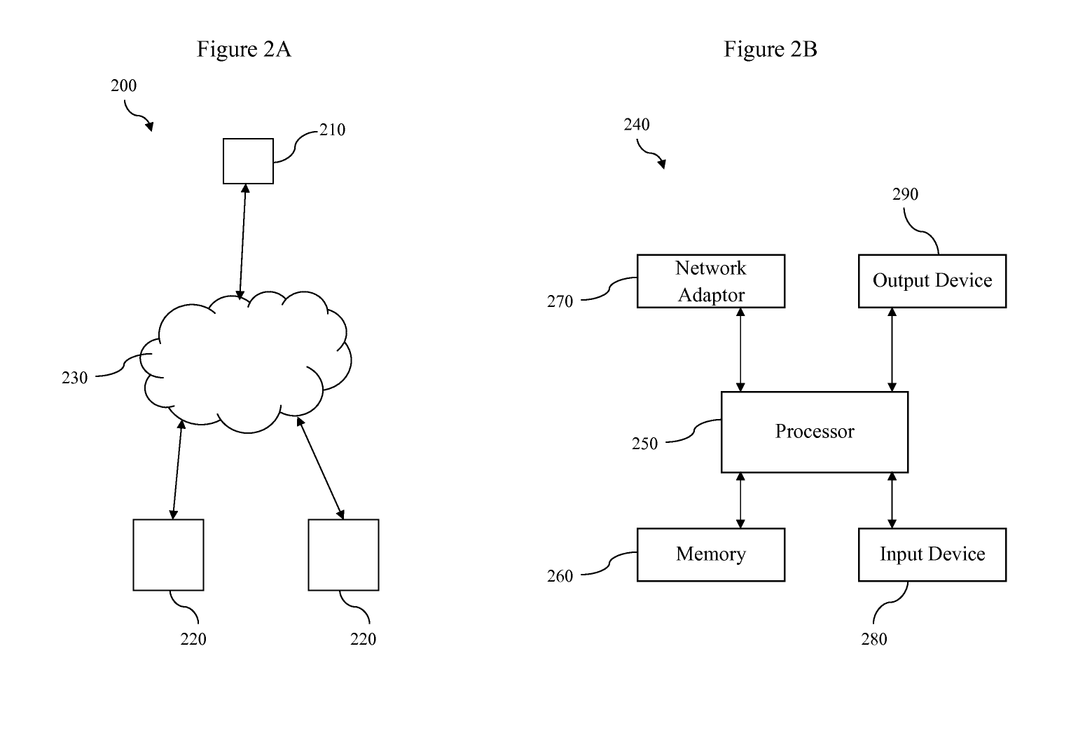

Referring now to FIG. 2A, a user interface navigation system 200 may comprise one or more computing devices. The one or more computing devices may be configured to exchange data to facilitate changing the information presented by one of the computing devices. In one embodiment, a user interface navigation system 200 may comprise a client device 210 and one or more servers 220 communicatively coupled to each other via one or more networks 230, which may be collectively configured to facilitate changing the information presented to a user of the client device 210. In some embodiments, the client device 210 and one or more servers 220 may be combined into a single device. In some embodiments, multiple servers 220 may be combined into a single device. As used herein, a computer system according to the present technology may comprise one or more client devices 210 and/or one or more servers 220.

The client device 210 and the one or more servers 220 may comprise any suitable computing device, for example a special-purpose computer, a general-purpose computer specifically programmed to implement or otherwise execute (whether alone or in combination with other one or more other computing devices) the systems and methods of the invention, and the like. Such a computing device may comprise a personal computer, server, mobile phone, smart phone, wearable computer, tablet computer, television, kiosk, and the like.

Referring now to FIG. 2B, the computing device 240 may comprise conventional components, such as any number of processors 250 communicatively coupled with any number of memory devices 260, any number of network adaptors 270, and any number of input 280 and/or output 290 devices such as a keyboard, mouse, monitor, touch-sensitive input device such as touch screen, touch sensor, and the like, microphone, speaker, motion sensor, orientation sensor, light sensor, and the like. A server 220 need not comprise an input device 280 and/or output device 290. The memory device 260 may comprise any combination of local memory such as RAM, long term memory such as a hard disk, and the like. The processor 250 may be configured to access (read and/or write) the memory device 260.

The memory device 260 may facilitate the storage of data and/or one or more computer instructions, such as a software routine and/or software program, which may be executable by the processor 250 to perform the methods of the invention. For example, the memory device 260 may store one or more of the listening module 110, routing module 120, and landing module 130, and/or any user information such as segment data (described below). In one embodiment, one or more servers 220 may store the listening module 110, routing module 120, and landing module 130. In some embodiments, the client device 210 may store the listening module 110. In an exemplary embodiment, the client device 210 stores the listening module 110, routing module 120, and landing module 130.

Some or all of the listening module 110, routing module 120, and/or landing module 130 may be exchanged between various client devices 210 and/or servers 220. In one embodiment, a portion of or the entire listening module 110 may be transferred to the client device 210 when the client device 210 downloads a website from the server 220. In one embodiment, the client device 210 may download a HTTP call to the server 220 (such as an advertising server) that may cause the server 220 to return code making up some or the entire listening module 110. In some embodiments, the server 220 may transfer some or the entire the routing module 120 and/or landing module 130 to the client device 210. In these and other exemplary embodiments, the client device 210 may execute the portions of the various modules that were received, and the portions not transferred to the client device 210 may be executed by the one or more servers 220.

The processor 250 may be configured to provide the output device 290 with content to present and may be configured to receive input from the input device 280. In one embodiment, the input device 280 may be integrated into the output device 290, such as in a touch screen display. In one embodiment, the computing device 240 may comprise a network adaptor 270 that allows the processor 250 to communicate with another computing device 240. For example, the network adaptor 270 may comprise an Ethernet adaptor, a wireless networking adaptor, a radio networking adaptor, a USB networking adaptor, and the like.

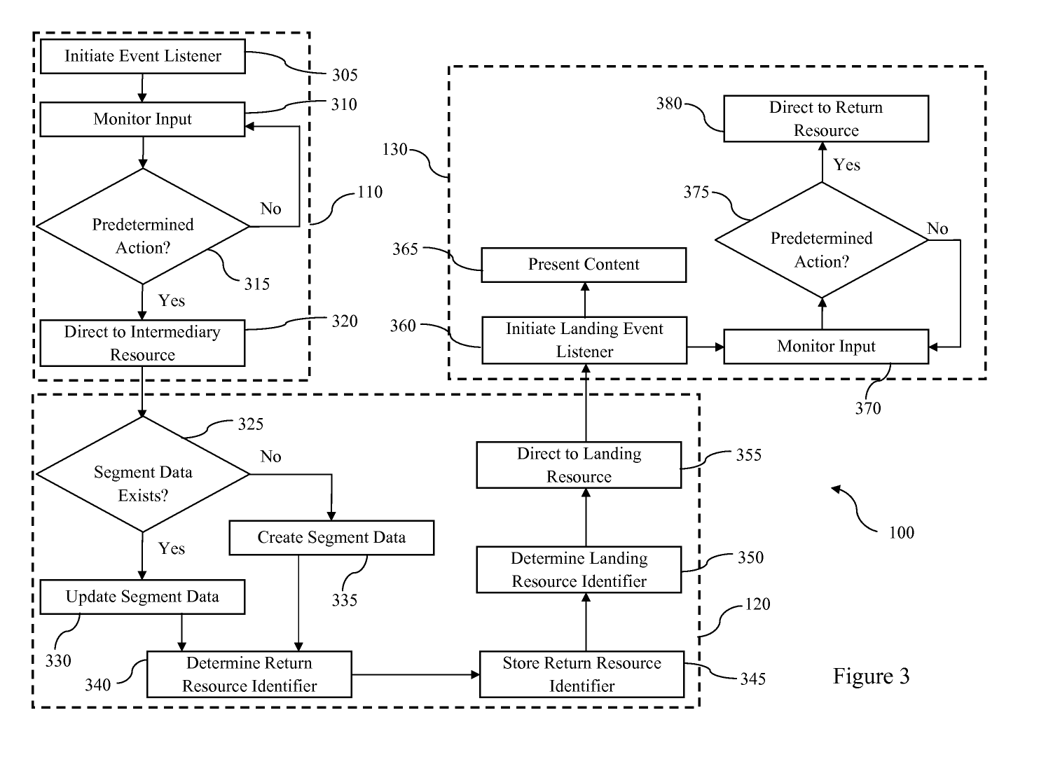

Referring now to FIG. 3, methods and apparatus for user interface navigation 100 may comprise the listening module 110 interacting with a routing module 120, and the routing module 120 interacting with the landing module 130. The listening module 110 may comprise initiating an event listener (305), monitoring input (310) received by an input device 280, continuing monitoring input (310) if the predetermined action has not been received (315), and directing the UI to an intermediary resource (320) if the predetermined action was received (315).

Monitoring input (310) may comprise any suitable system or method for observing user input and determining if a predetermined action has been input by the user. In one embodiment, monitoring input (310) may comprise executing software code to observe user input and check if user input matches one or more predetermined actions. For example, if the predetermined action comprises pressing the spacebar key twice consecutively, monitoring input (310) may comprise observing user input and checking if the spacebar key has been pressed, and if so, whether the next keystroke is the spacebar key. In an exemplary embodiment, monitoring input (310) comprises initiating a JavaScript event listener to observe user keystrokes, initiating a JavaScript Timeout lasting approximately 200 ms upon observing a spacebar keystroke, and determining that a predetermined action has been input if another spacebar keystroke is observed before the expiration of the JavaScript Timeout.

The predetermined action may comprise any action observable by the UI and/or a computing device 240 the UI is operating on. For clarity, “observe” as used herein also encompasses “perceive” or any other way of knowing the input to the computing device 240. For example, the UI may comprise a web browser, and the predetermined action may comprise pressing a sequence of keyboard keys, such as pressing the spacebar twice, and possibly within a certain time limit. For further example, the UI may comprise a smart phone, and the predetermined action may comprise shaking the smart phone. The predetermined action may comprise a touch event, such as a double tap on a touch screen or other touch input sensor. The predetermined action may comprise a double tap on a touch screen within any desirable or predetermined time limit, for example two taps within approximately 200 ms of each other. The predetermined action may comprise a gesture input using a touch interface, such as moving a finger across a touch screen of the computing device 240 the UI is operating on. The predetermined action may comprise a gesture input using any suitable input device 280 capable of accepting gesture input, such as a Microsoft® Kinect® device. The predetermined action may comprise change of orientation of the computing device 240 the UI is operating on. The predetermined action may comprise an input received by the network adaptor 270.

The predetermined action may be settable, selectable, or otherwise suitable for a particular type of computing device 240, for example by the user of the UI, an administrator, and the like. In one embodiment, a plurality of predetermined actions may be selected, where each predetermined action may cause the UI to change or alter the output uniquely depending on the predetermined action, or non-uniquely. For example, the UI may comprise a web browser, and a first predetermined action comprising pressing the space bar twice may cause the web browser to display a first web page, and a second predetermined action comprising pressing the Home key twice may cause the web browser to display a second web page.

Directing the UI to an intermediary resource (320) may comprise any suitable system or method for directing the UI to a resource. Directing the UI to the intermediary resource (320) may comprise the UI executing a URI reference. In an exemplary embodiment, the UI comprises a web browser and directing the UI to the intermediary resource (320) comprises setting location.href in JavaScript to a predetermined URL identifying the intermediary resource. Directing the UI to the intermediary resource (320) may comprise first determining the identity of the intermediary resource, for example by reading a variable and/or based on any other information. The intermediary resource may comprise the routing module 120. For example, the routing module 120 may comprise software code in a file on a server 220, and directing the UI to the intermediary resource (320) may comprise directing the UI to the file on the server 220.

Initiating an event listener (305) configures the monitoring of input (310) and/or the directing of the UI to an intermediary resource (320). The event listener may comprise the steps of monitoring input (310), checking for the predetermined action (315), and directing the UI to the intermediary resource (320). Initiating the event listener (305) may comprise determining which one or more predetermined actions will be looked for when monitoring the input (310). Initiating the event listener (305) may comprise determining what intermediary resource the UI will be directed to (320) upon observing the predetermined action. In some embodiments, initiating an event listener (305) is not necessary, for example when the predetermined action and intermediary resource are fixed, hardcoded, and the like.

The routing module 120 manages segment data, manages an identifier of a return resource, and/or facilitates loading of the landing module 130. Still referring to FIG. 3, the routing module 120 checks if segment data exists (325), creates segment data (335) if it does not exist, updates segment data (330) if it does exist, determines a return resource identifier (340), stores the identifier of the return resource (345), determines an identifier of a landing resource (350), and directs the UI to the landing resource (355). The routing module 120 may comprise software code, and may be stored on a client device 210. For example, the routing module 120 may exist as part of or an entire software application resident on the client device. The routing module 120 may be stored on the server 220. The routing module 120 may be downloaded to the client device 210 to be executed by the client device 210. For example, the routing module 120 may comprise JavaScript in a HTML document downloaded and executed by the client device 210. The routing module 120 may be executed by the server 220. For example, the routing module 120 may comprise software code executed by the sever 220 in response to the UI being directed, by the listening module 110, to a resource on the server 220. The routing module 120 may be executed by any combination of the above or in any other suitable manner.

Segment data represents one or more characteristics related to the user. Segment data may comprise information such as gender, age, geographic location, and the like. Segment data may comprise information relating to the likes and desires of the user. For example, segment data may comprise the type and/or category of news and/or content the user likes, such as local news, sports, business, and the like. Segment data may comprise information relating to how much of a particular type of content the user would like to see. For example, segment data may indicate that a preference of only 1 out of 10 for sports news, but a preference of 9 out of 10 for business news. Segment data may comprise information corresponding to a landing resource. For example, segment data may comprise a user preference to open a particular application and/or location, such as a particular web browser and/or a particular webpage, upon performing the predetermined action. Segment data may comprise information relating to likes and dislikes of the user, information relating to personality type, and any other data suitable for targeting content and/or advertising to the user.

Segment data may be user-supplied or otherwise determined. For example, a user may select content and/or advertising preferences using sliders for one or more categories to determine an absolute or relative amount of content the user would like to see from each category. In one embodiment, the user may sign into a Facebook account, and segment data may determined by analyzing the user's “Likes,” the categories of the user's “Likes,” the user's comments, and the like. In one embodiment, the routing module 120 may cause the UI to present options, such as radio buttons, check boxes, sliders, forms, and the like, which the user can use to submit segment data.

Segment data may be stored in any suitable manner. Segment data may be stored in a web browser cookie on the client device 210. In one embodiment, the routing module 120 may comprise software code at a fixed domain (e.g. a constant URL), and segment data may be stored in a persistent first-party cookie belonging to that domain. Segment data may be stored in a database accessible by a server 220 and/or client device 210. In one embodiment, a user identifier may be stored in a web browser cookie on the client device 210 which may be used by the server 220 to access the user's segment data from the database. Segment data may be stored on a client device 210 outside of a web browser environment.

Managing segment data may comprise checking if segment data exists (350, creating segment data (335) if it does not exist, and updating segment data (330) if it does exists. Creating segment data (335) may comprise any suitable system or method for creating an identifiable location to store the user's segment data. In one embodiment, creating segment data (335) comprises creating a new web browser cookie, on the client device 210, belonging to the domain housing the routing module 120 (a “segment cookie”). The segment cookie may be left empty, or may be filled with any segment data available or determinable by the routing module 120. In one embodiment, creating segment data (335) comprises creating a new database entry for storing segment data related to the user, and may comprise creating a segment cookie, on the client device 210, containing an identifier that can be used to access segment data in the database.

Updating segment data (330) may comprise any suitable system or method for refreshing and/or updating the user's segment data. In one embodiment, updating segment data (330) may comprise extending the expiration date of the segment cookie, refreshing a maximum age attribute, or otherwise refreshing its duration. In one embodiment, updating segment data (330) may comprise updating segment data with any segment data available or determinable by the routing module 120. In one embodiment, segment data is not updated (330) every time the routing module 120 executes. In one embodiment, updating segment data (330) may comprise creating another segment cookie, for example if the existing segment cookie has or will reach its maximum size. Creating segment data (335) may comprise updating segment data (330). Checking if segment data exists (325) may be done in any suitable manner. In one embodiment, checking if segment data exists (325) may comprise determining whether the HTTP request, from the UI as caused by the listening module 110, included the segment cookie. In one embodiment, checking if segment data exists (325) may comprise determining if an entry in a relevant database exists for the user's segment data.

Segment data may be managed locally and/or remotely. In embodiments having a segment cookie, the segment cookie may be read, set, and/or updated by the routing module 120. In an exemplary embodiment, the routing module 120 may create (335) or update (330) the segment cookie via a HTTP response sent from the server 220 to the client device 210. In another exemplary embodiment, the routing module 120 may transmit software code, such as JavaScript, to the client device 120, which may then execute and create (335) or update (330) the segment cookie.

Determining a return resource identifier (340) and storing the identifier of the return resource (345) facilitates easier navigation by the user. A resource identifier may comprise anything suitable for finding, accessing, or otherwise referencing a resource. A return resource may comprise the resource that the UI will be directed to upon receiving a second predetermined action and/or leaving the landing module 130. In an exemplary embodiment, the return resource may comprise the website from which the listening module 110 directed the UI to the routing module 120 (the “originating website”).

Determining the return resource identifier (340) may comprise any suitable system or method for determining the return resource. In one embodiment, determining the return resource identifier (340) may comprise obtaining the URL from which the HTTP request to the routing module 120 was sent, for example from the HTTP request itself. In one embodiment, the listening module 110 may pass the URL of the listening module 110, a pre-set URL, or an otherwise determined URL as a URL parameter when directing the UI to the routing module 120, and determining the return resource identifier (340) may comprise obtaining the return resource identifier from the received URL parameter.

The return resource identifier may also be determined (340) based on segment data, based on the website, domain, and the like the routing module 120 was called from, and/or based on the identity of the user or a user preference. In one embodiment, the return resource identifier may be determined (340) based in part on the landing resource that the UI will be directed to (355). For example, the owner of the landing resource may desire that upon a second predetermined action, the UI is directed to a specified return resource (for example the owner's homepage). In one embodiment, the return resource may be predetermined or otherwise fixed, and determining the return resource identifier (340) may not be required.

In one embodiment, determining the return resource identifier (340) may comprise determining an identifier of the content currently presented by the interface that will operate the landing resource. For example, the UI may comprise an operating system desktop environment, a web browser may be open and presenting a first resource, and determining the return resource identifier (340) may comprise determining the identifier of the first resource. In this example, the web browser may be returned to the resource that was presented prior to the predetermined action (the first resource) upon the occurrence of a second predetermined action (described below). Notably, the UI comprising the operating system desktop environment may be considered to comprise the web browser interface operating in the operating system desktop environment.

Storing the return resource identifier (345) allows the UI to be directed to the return resource after the UI is directed to the landing module 130 or otherwise away from the routing module 120. The same or similar methods used for storing segment data may be used to store the return resource identifier (345). In one embodiment, the return resource identifier may be stored (345) in a session cookie. In some embodiments, the session cookie may be created or updated using a HTTP response or JavaScript sent to the client device 110, as described in relation to the segment cookie. In an alternative embodiment, storing the return resource identifier (345) may comprise passing the landing resource identifier to the landing module as a URL parameter. In yet another embodiment, storing the return resource identifier (345) may comprise storing the return resource identifier to the client device 210 outside of a web browser environment.

Determining the landing resource identifier (350) may comprise any suitable system or method for determining the landing resource. The landing resource may comprise the ultimate target of the initial predetermined action. In one embodiment, the landing resource may comprise the target resource to be loaded (including possible execution) when the user, viewing a first website, performs the predetermined action. For example, the UI may be presenting a first website featuring an advertisement, the landing resource may comprise the advertiser's website, and performing the predetermined action will ultimately result in the advertiser's website being presented. For further example, the landing resource may comprise a user's page on a social media website, an application to be opened, a search engine, and the like. The landing resource may comprise the landing module 130. For example, the landing module 130 may comprise software code in a file on a server 220, and directing the UI to the landing resource (355) may comprise directing the UI to the file on the server 220.

In one embodiment, the listening module 110 may pass a pre-set URL or an otherwise determined URL as a URL parameter when directing the UI to the routing module 120, and determining the landing resource identifier (350) may comprise obtaining the landing resource identifier from the received URL parameter. The landing resource identifier may also be determined (350) based on segment data, based on the website, domain, and the like the routing module 120 was called from, and/or based on the identity of the user or a user preference. In one embodiment, a lookup table may have an input as the originating website, a partner id, and the like, and an output as the landing resource identifier. In one embodiment, the landing resource may be predetermined or otherwise fixed, and determining the landing resource identifier (345) may not be required.

Directing the UI to the landing resource (355) may comprise any suitable system or method for directing the UI to a resource. Directing the UI to the landing resource (355) may comprise the UI executing a URI reference. In an exemplary embodiment, the UI comprises a web browser and directing the UI to the landing resource (355) comprises setting location.href in JavaScript to the determined landing resource identifier. Directing the UI to the landing resource (355) may comprise opening a child interface. A child interface may comprise an interface operating under the control of or in association with the UI. In one embodiment, the UI may comprise an operating system desktop environment, and the child interface may comprise a web browser operating in the desktop environment. The UI may be considered to comprise the child interface. For example, directing (355) the desktop environment (the UI) to a website (landing resource) may comprise opening and/or directing a web browser (child interface) to the landing resource.

The landing module 130 receives users that have been processed by the routing module 120. Still referring to FIG. 3, the landing module 130 may comprise initiating a landing event listener (360), presenting content (365), monitoring input (370) received by an input device 280, continuing monitoring input (370) if a second predetermined action has not been received (375), and directing the UI to the return resource (380) if the second predetermined action was received (375). The landing module 130 may comprise software code, and may be stored on a server 220. The landing module 130 may be downloaded to a client device 210 to be executed by the client device 210. For example, the landing module 130 may comprise JavaScript in a HTML document downloaded and executed by the client device 210. The landing module 130 may be executed by the server 220. For example, the landing module 130 may comprise software code executed by the server 220 in response to the UI being directed, by the routing module 120, to a resource on the server 220. The landing module 130 may be executed by any combination of the above or in any other suitable manner.

Monitoring input (370) for the second predetermined action may comprise any suitable system or method for observing user input and determining if a predetermined action has been input by the user, as previously described for the monitoring of input (310) in the listening module 110. The second predetermined action may comprise any predetermined action. The second predetermined action may comprise the same or different action as monitored for the by listening module 110. For example, if the listening module 110 monitored for a double tap of the spacebar, the landing module 130 may also monitor for a double tap of the spacebar, or may monitor for any other predetermined action.

Initiating a landing event listener (360) configures the monitoring of input (370) and/or the directing of the UI to the return resource (380). The landing event listener may comprise the steps of monitoring input (370), checking for the second predetermined action (375), and directing the UI to the return resource (380). Initiating the landing event listener (360) may comprise determining which one or more predetermined actions will be looked for when monitoring the input (370). Initiating the landing event listener (360) may comprise determining what return resource the UI will be directed to (380) upon observing the second predetermined action. Initiating the landing event listener (360) may comprise determining the return resource by observing the return resource identifier stored (345) by the routing module 120. In some embodiments, initiating the landing event listener (360) is not necessary, for example when the second predetermined action and return resource are fixed, hardcoded, and the like.

Directing the UI to the return resource (380) may comprise any suitable system or method for directing the UI to a resource. Directing the UI to the return resource (380) may comprise the UI executing a URI reference. In an exemplary embodiment, the UI comprises a web browser and directing the UI to the return resource (380) comprises setting location.href in JavaScript to the return resource identifier determined (340) by the routing module 120.

Presenting content (365) may comprise any suitable system or method for causing the UI to present content. In one embodiment, presenting content (365) may comprise causing the client device 210 to retrieve content and/or sending content to the client device 210 to be opened by the UI. For example, presenting content (365) may comprise sending a HTML document to a web browser on the client device 210, where it may be opened, executed, and presented to the user.

In one embodiment, presenting content (365) may comprise retrieving and/or generating content. Content retrieval and/or generation may be performed at the server 220 executing part of the landing module 130, at the client device 210 executing part of the landing module 130, or any combination thereof. If content is retrieved and/or generated by the server 220, presenting content (365) may comprise sending the content to the client device 210 to be presented by the UI. Content retrieval and/or generation may be based on the stored segment data. For example, the server 220 and/or client device 210 may access the segment cookie to determine what content to generate. In one embodiment, the routing module 120 may pass the segment cookie to the landing module 130 via a HTTP request. For further example, the client device 210 may access segment data stored outside of a web browser environment to determine what content to generate. If no segment data has been set or the segment data is blank or invalid, generic or default content may be presented (365).

The landing resource may reside at the same or different domain than the routing module 120. If the landing resource resides at the same domain as the routing module, then the server 220 operating the landing module 130 may have access to the segment cookie. If the landing resource resides at a different domain than the routing module 120, then the client device 210 may be required to execute some of the landing module 130, such as using JavaScript, to access the segment cookie. In either case, the client device 210 may execute some or the entire landing module 130 and may have access to the segment cookie.

The landing module 130 may facilitate user submission of segment data. For example, the landing module 130 may allow the user to select content and/or advertising preferences using sliders for one or more categories to determine an absolute or relative amount of content the user would like to see from each category. In one embodiment, the user may sign into a social networking account, and segment data may determined by analyzing the user's “Likes,” the categories of the user's “Likes,” the user's comments, and the like. In one embodiment, the landing module 130 may cause the UI to present options, such as radio buttons, check boxes, sliders, forms, and the like, which the user can use to submit segment data.

In an exemplary embodiment, methods and apparatus for user interface navigation 100 may comprise one or more listening modules 110, one routing module 120, and one or more landing modules 130. For example, the listening module 110 may be implemented on one or more websites, and possibly the client device 210 as an application, the landing module 130 may be implemented on various websites, and the routing module 120 may determine which website to direct the user to in response to a predetermined action, based on the originating website, segment data, and/or the like.

As described, methods and apparatus according to various aspects of the present technology may comprise a software application. The software application may be run as part of the UI, part of the UI output, and/or separately from the UI. For example, the UI may comprise a web browser. The software application may be executed as part of the web browser, such as in the form of a web browser add-on. The software application may be executed as software code contained within the displayed web page, such as through the use of JavaScript. The software application may be executed as a stand-alone software application. For example, the software application may comprise a smart phone application or an application operating on a personal computer.

In an exemplary embodiment, one or more of the listening module 110, routing module 120, and landing module 130 may operate as an independent or semi-independent application. For example, the listening module 110 may operate on the client device 210 as a stand-alone application, a web browser add-on, and the like, and upon observing a predetermined action, may cause (320) a web browser to activate (opening, directing, and the like) to a resource containing the routing module 120, which may then determine which landing resource (350) to direct the web browser to (355). The resource containing the routing module may comprise software code and the like residing on the client device 210, for example a HTML document. The resource containing the routing module may comprise software code residing on the sever 220. The return resource may be identified (340) as the last page visited by the browser or the page being presented when the predetermined action occurred. A second predetermined action may close the browser, or may direct the browser (380) to the return resource. Furthering the example, the web browser may be navigated to a website also comprising the listening module 110, which may or may not take precedent over the background listening module 110.

In an exemplary embodiment, the listening module 110 and routing module 120 may operate on the client device 210 as part of or an entire stand-alone application, web browser add-on, and the like. The UI may comprise the operating system desktop environment. Upon observing a predetermined action, the listening module 110 may direct (320) the operating system to execute the routing module 120. The routing module may cause (355) the web browser to activate (opening, directing, and the like) to the landing resource, and may identify the return resource (340) as the last page visited by the browser or the page being presented when the predetermined action occurred. In one embodiment, the landing module 130 may also operate on the client device 210 as part of or an entire stand-alone application, web browser add-on, and the like. A second predetermined action may close the browser, or may direct the browser to the return resource (380).

In an exemplary embodiment, methods and apparatus for user interface navigation 100 may allow a first website to direct a user to a second website, for example a website of an advertiser having an advertisement on the first website, when the predetermined action occurs and may allow the user to be directed back to the first website (possibly based on a second predetermined action, and possibly only after a predetermined amount of time). In an exemplary embodiment, methods and apparatus for user interface navigation 100 may allow a search website to direct the user to the home search webpage upon the occurrence of a predetermined action. For example, if the user is viewing search results for a first search, the user can start a new search by inputting a predetermined action, directing (355) them to the home search page. Further, after the user performs the new search, the user may be able to return to the first search results (380) by inputting a second predetermined action.

In some alternative embodiments, a more simplified version of the methods and apparatus for user interface navigation 100 may be implemented. In an exemplary embodiment, where the landing resource is an email window opened using a “mailto” URI scheme, the landing module 130 may not be required, for example if the routing module 120 directs the UI to the return resource. In another exemplary embodiment, the listening module may operate independently. For example, the intermediary resource may be determined to be an application, such as an email window opened using a “mailto” URI scheme, which may leave the UI at the original resource.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A computer-implemented method for directing a user interface operating on a computer from a first resource to an intermediary resource and to a landing resource, comprising:
monitoring, by the computer, an input of the computer for a predetermined action;
directing, by the computer and in response to observing the predetermined action, the user interface from the first resource to the intermediary resource;
managing a segment data stored on the computer;
determining an identifier of a return resource;
determining an identifier of the landing resource;
directing, by the computer, the user interface to the landing resource using the identifier of the landing resource;
directing, by the computer, the user interface from the landing resource to the return resource using the identifier of the return resource.

2. A computer-implemented method according to claim 1, wherein managing the segment data stored on the computer comprises:
determining, by a first server operating the intermediary resource, if the segment data was received from the computer;
refreshing the segment data if the segment data was received; and
creating the segment data if the segment data was not received.

3. A computer-implemented method according to claim 1, further comprising presenting, by the computer and according to the landing resource, content based on the segment data.

4. A computer-implemented method according to claim 3, wherein:
directing the user interface to the landing resource comprises sending, by the computer, the segment data to the landing resource; and
presenting content based on the segment data comprises sending, by a second server operating the landing resource, the content to the computer based on the segment data.

5. A computer-implemented method according to claim 1, wherein:
determining the identifier of the return resource comprises obtaining the identifier of the first resource; and
the identifier of the landing resource is determined according to the segment data.

6. A computer-implemented method according to claim 1, wherein:
determining the identifier of the return resource comprises storing the identifier of the return resource to the computer; and
directing the user interface to the return resource comprises using the stored identifier of the return resource.

7. A computer-implemented method according to claim 1, wherein the predetermined action comprises two consecutive taps of a touch-sensitive input device.

8. A computer-implemented method according to claim 1, wherein the predetermined action comprises two activations of a keyboard key less than or equal to about 200 ms apart in time.

9. A computer system, comprising client device, for directing a user interface operating on the client device from a first resource to an intermediary resource and to a landing resource and configured to:
monitor an input of the client device for a predetermined action;
direct, in response to observing the predetermined action, the user interface from the first resource to the intermediary resource;
manage a segment data stored on the computer system;
determine an identifier of a return resource;
determine an identifier of the landing resource;
direct the user interface to the landing resource using the identifier of the landing resource;
direct the user interface from the landing resource to the return resource using the identifier of the return resource.

10. A computer system according to claim 9 further comprising a server operating the intermediary resource, wherein managing the segment data comprises the server:
determining if the segment data was received from the client device;
refreshing the segment data if the segment data was received; and
creating the segment data if the segment data was not received.

11. A computer system according to claim 9, further configured to present, according to the landing resource, content based on the segment data.

12. A computer system according to claim 11 further comprising a second server operating the landing resource, wherein:
directing the user interface to the landing resource comprises sending the segment data to the landing resource; and
presenting content based on the segment data comprises the second server sending, based on the segment data, the content to the client device.

13. A computer system according to claim 9, wherein:
determining the identifier of the return resource comprises obtaining the identifier of the first resource; and
the identifier of the landing resource is determined according to the segment data.

14. A computer system according to claim 9, wherein:
determining the identifier of the return resource comprises storing the identifier of the return resource to the client device; and
directing the user interface to the return resource comprises using the stored identifier of the return resource.

15. A computer system according to claim 9, wherein the predetermined action comprises two consecutive taps of a touch-sensitive input device.

16. A computer system according to claim 9, wherein the predetermined action comprises two activations of a keyboard key less than or equal to about 200 ms apart in time.

17. A non-transitory computer-readable medium storing computer-executable instructions for directing a user interface, wherein the instructions are configured to cause a computer system comprising a client device to:
monitor an input of the client device for a predetermined action;
direct, in response to observing the predetermined action, the user interface from the first resource to the intermediary resource;
manage a segment data stored on the computer system;
determine an identifier of a return resource;
determine an identifier of the landing resource;
direct the user interface to the landing resource using the identifier of the landing resource;
direct the user interface from the landing resource to the return resource using the identifier of the return resource.

18. A non-transitory computer-readable medium according to claim 17, wherein the computer system further comprises a server operating the intermediary resource, and the instructions configured to cause the computer system to manage the segment data cause the server operating the intermediary resource to:
determine if the segment data was received from the client device;
refresh the segment data if the segment data was received; and
create the segment data if the segment data was not received.

19. A non-transitory computer-readable medium according to claim 17, wherein the instructions are further configured to cause the computer system to present, according to the landing resource, content based on the segment data.

20. A non-transitory computer-readable medium according to claim 19, wherein:
directing the user interface to the landing resource comprises sending the segment data to the landing resource; and
the computer system further comprises a second server operating the landing resource, and the instructions configured to present content based on the segment data cause the second server to send, based on the segment data, the content to the client device.

21. A non-transitory computer-readable medium according to claim 17, wherein:
determining the identifier of the return resource comprises obtaining the identifier of the first resource; and
the identifier of the landing resource is determined according to the segment data.

22. A non-transitory computer-readable medium according to claim 17, wherein:
determining the identifier of the return resource comprises storing the identifier of the return resource to the client device; and
directing the user interface to the return resource comprises using the stored identifier of the return resource.

23. A non-transitory computer-readable medium according to claim 17, wherein the predetermined action comprises two consecutive taps of a touch-sensitive input device.

24. A non-transitory computer-readable medium according to claim 17, wherein the predetermined action comprises two activations of a keyboard key less than or equal to about 200 ms apart in time.
